(19) United States
(12) Patent Application Publication
(10) Pub. No.: US 2023/0356947 A1
(43) Pub. Date: Nov. 9, 2023

(54) WAREHOUSE AUTOMATION USING AUTONOMOUS MOBILE ROBOTS

(71) Applicant: Nasir Khalil Memon, Piscataway, NJ (US)

(72) Inventor: Nasir Khalil Memon, Piscataway, NJ (US)

(21) Appl. No.: 17/738,066

(22) Filed: May 6, 2022

(51) Int. Cl. B65G 1/137; B65G 1/04; G05D 1/02; G10L 15/22

(52) U.S. Cl. CPC B65G 1/1375; B65G 1/0492; G05D 1/0234; G05D 1/0297; G10L 15/22; G05D 2201/0216

(57) ABSTRACT

Disclosed is a system and method for automating the movement of goods within a warehouse. A rotating camera is attached to an autonomous mobile robot, which can detect markers placed on the warehouse floor. Accurate positioning and navigation is enabled using the rotating camera and floor markers. The system enables increased productivity of warehouse order picking operations. A central server communicates with the autonomous mobile robot and warehouse personnel carrying handheld devices. The central server instructs the autonomous mobile robot to stop at specific locations within a warehouse and informs warehouse personnel to load or unload specific items onto the autonomous mobile robot.

### TECHNICAL FIELD

The present invention generally relates to warehouses, logistics, manufacturing, and supply chain automation systems. More specifically, the present invention relates to systems and methods for inventory movement and order picking within a warehouse. Autonomous mobile robots work alongside people in moving inventory within a warehouse.

### BACKGROUND ART

A logistics facility or warehouse is primarily used for storage of goods for commercial purposes. Generally the storage of goods in the warehouse is intended to be temporary for a retailer, customer, distributor, transporter, manufacturer, etc. The stored goods may be small, large, or bulk. The goods may come and go frequently, throughout the day, in a warehouse. Furthermore, with the rapid growth of e-commerce, users such as warehouse managers are under constant pressure to lower costs. The common costs for a logistics facility include receiving items, storage, picking items and shipping.

Manual labor is typically required to move, receive, store, pick and ship items within a warehouse. Many warehouses now use some form of automation to improve goods movement such as for order picking. Several existing automation solutions can be limited by the time it takes to deploy, size or weight of the goods, availability of open space and the cost to install a system. Hence there is a need to continue to develop improved methods and systems to increase overall warehouse productivity.

The common costs for a logistics facility include receiving items, storage, picking items and shipping. Presently, out of the aforementioned costs, item picking typically accounts for the majority of the cost associated with warehouse operations. The item picking process may be divided into two categories, 1) picker-to-goods and 2) goods-to-picker. Picker-to goods is traditionally used in numerous warehouses, where a person walks across the warehouse and brings items from different locations. This manual process is time consuming and expensive and thus has received much attention by logistics managers. Goods-to-picker is typically a highly automated system that allows pickers to remain in a fixed location. Automated Storage and Retrieval Systems (AS/RS) is an example of a goods-to-picker system, where individual bins can be carried by a machine from a fixed storage rack and delivered to a person stationed at a picking station. A drawback of the current goods-to-picker technology is that it typically requires significant infrastructure changes.

The present invention is directed at improving goods movement within a warehouse and overall productivity for item picking. Additionally the autonomous mobile robot and system are designed to help lower overall cost of automation within warehouses.

### SUMMARY OF THE EMBODIMENTS

The presently disclosed invention overcomes many limitations of the prior art related to moving goods within a warehouse. Typical autonomous mobile robots will require a LIDAR for localization and mapping of a facility to navigate autonomously. In the present invention, an autonomous mobile robot is equipped with a rotating camera that can detect markers placed in a warehouse for navigation within a warehouse.

The presently disclosed invention allows for autonomous mobile robots to work alongside warehouse personnel. Furthermore warehouse personnel are equipped with a handheld device which instructs them to load or unload specific items from an autonomous mobile robot. Additionally the handheld device has a barcode scanner that can be used to verify the correct item has been loaded or unloaded from the autonomous mobile robot.

The presently disclosed invention includes a central server that communicates with the autonomous mobile robot and personnel handheld device. In one instance, the central server receives order information from a warehouse management system and instructs the autonomous mobile robot to drive to a specific location. The autonomous mobile robots are able to autonomously navigate on a specified path and position themselves within the warehouse using a rotating camera and markers placed in the warehouse. The central server also instructs warehouse personnel using the handheld device to go to a specific autonomous mobile robot and load/unload items from the robot.

The presently disclosed invention allows for the operation of many robots and warehouse personnel working together. The autonomous mobile robot can vary in size and can be configured to hold items of various sizes or shapes, such as clothes, bins or boxes.

### BRIEF DESCRIPTION OF THE DRAWINGS

The accompanying drawings illustrate the embodiments of systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1A and FIG. 1B are the 2-D side and 3-D views, respectively, of the autonomous mobile robot, in accordance with some aspects of the presently disclosed invention.

FIG. 2 is the rotating camera that is mounted on the autonomous mobile robot, in accordance with some aspects of the presently disclosed invention.

FIG. 3 is a simplified view of the autonomous mobile robot detecting markers placed on the floor for navigation, in accordance with some aspects of the presently disclosed invention.

FIG. 4 Illustrates the autonomous mobile robot driving within a warehouse and using floor markers for navigation, in accordance with at least one embodiment.

FIG. 5 is a side view of multiple autonomous mobile robots where markers are attached at the back of the robot, in accordance with at least one embodiment.

FIG. 6 illustrates a warehouse personnel using a handheld device to verify items that are being loaded or unloaded for an autonomous mobile robot, in accordance with some aspects of the presently disclosed invention.

FIG. 7 illustrates the handheld device screen interface that instructs the warehouse personnel, in accordance with at least one embodiment.

FIG. 8 is a block diagram of the system. The system has autonomous mobile robots, central server, handheld devices, and a WMS in accordance with some aspects of the presently disclosed invention.

FIG. 9 is a simplified top view floor plan diagram of an indoor space where the autonomous mobile robot navigates between different locations in a warehouse to move inventory, in accordance with at least one embodiment.

FIG. 10 is a simplified top view floor plan diagram of a warehouse where the autonomous mobile robot and warehouse personnel are picking orders.

FIG. 11 illustrates the autonomous inventory mobile robot storing different items, in accordance with at least one embodiment.

FIG. 12 illustrates a warehouse personnel using a handheld device and a headset with audio and voice to receive instructions on loading or unloading items onto the autonomous mobile robot.

### DETAILED DESCRIPTION OF SPECIFIC EMBODIMENTS

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. Therefore, any approach may extend beyond certain implementation choices in the following embodiments.

References to “one embodiment,” “at least one embodiment,” “an embodiment,” “one example,” “an example,” “for example,” and so on indicate that the embodiment(s) or example(s) may include a particular feature, structure, characteristic, property, element, or limitation, but not every embodiment or example necessarily includes that particular feature, structure, characteristic, property, element, or limitation. Furthermore, repeated use of the phrase “in an embodiment” does not necessarily refer to the same embodiment.

Unless defined otherwise, all technical and scientific terms used herein have the same meaning as commonly understood by one of the ordinary skills in the art to which this invention belongs. Although any method and material similar or equivalent to those described herein can also be used in the practice or testing of the present invention, the preferred methods and materials have been described.

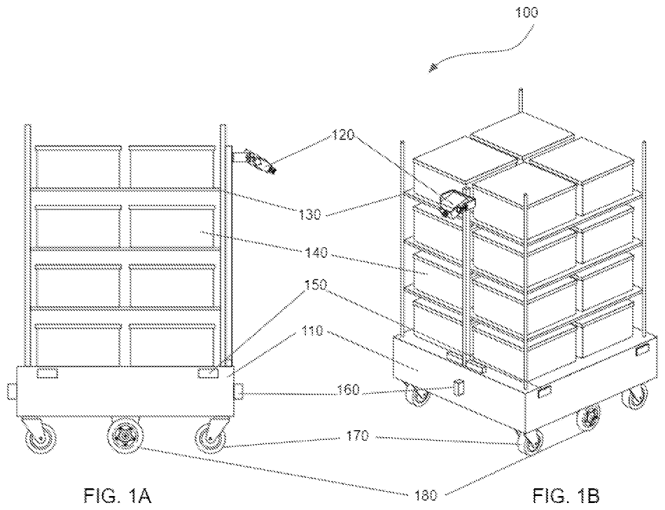

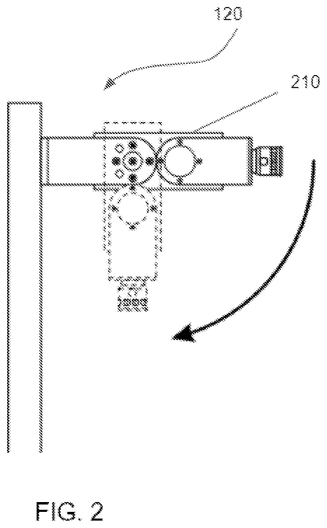

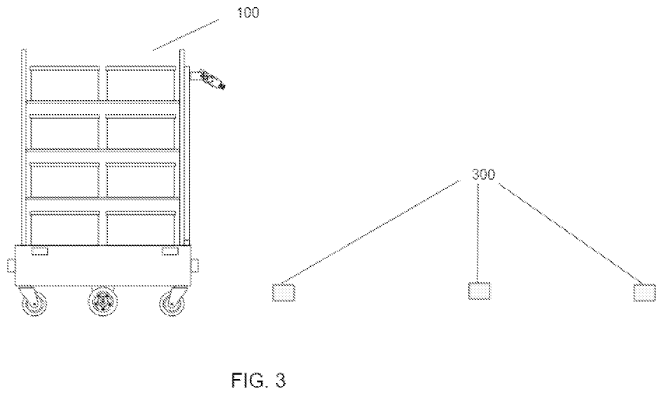

FIGS. 1A and 1B are 2-D and 3-D, respectively, external views of the autonomous mobile robot 100. A rotating camera, 120, is shown in FIG. 1 and FIG. 2. The rotating camera enables autonomous navigation of the robot by detecting markers, 300 (FIG. 3) placed within an indoor facility such as a warehouse. By rotating the camera at different angles, the robot can detect markers placed at various distances and also when the marker is directly underneath the camera. Markers that are placed on the floor, 300, can be standard fiducial markers such as AprilTags, Aruco markers, and QR codes. Using a standard PID controller, the rotating camera is always locked onto at least one marker for precise navigation within a warehouse. As the autonomous mobile robot is driving within a warehouse, a marker will eventually be outside the camera field of view, in this case the robot will find the next marker which can be used for autonomous navigation. Additionally the rotating camera can detect obstacles, such as warehouse personnel, which can be used to stop the autonomous mobile robot. In one embodiment, a servo motor 210 is used to precisely rotate the camera. Also different camera lenses that modify the focal length can be used to optimize the min and max distance for marker detection. Cameras are either equipped with a rolling or global shutter. A global shutter typically allows for better resolution on a moving robot.

The autonomous mobile robot is equipped with shelves 130 that can hold totes, bins 140 or individual items. In one embodiment, the autonomous mobile robot is equipped with two brushless direct current (BLDC) hub motors 180, which are mounted to the mobile base 110. Other motors such as brushed direct current, alternating current (AC) induction, stepper, and permanent magnet synchronous (PMSM) motors can also be used. The two BLDC hub motors 180 enable the robot to move using a differential drive system, where two hub motors are used to drive the autonomous inventory rack and if the motors rotate at different speeds, it enables the robot to turn. Other drive systems such as Ackerman steering can also be used to move the inventory racks. The mobile base 110 also uses passive wheels, such as casters 170 for stabilization and weight distribution. Two LIDARs 160 are mounted on opposite sides of the autonomous mobile robot 100. The LIDARs are primarily used for obstacle detection but can also assist with localization of the robot. Other sensors such as 3-D depth cameras, laser ranging devices, ultrasonic range finder, infrared range sensor, or any combination can also be mounted. The sensors are used to detect obstacles. Lights 150 are mounted to the mobile base that are used to indicate the driving status of the autonomous mobile robot. Onboard rechargeable batteries are located inside the mobile base 110. Various battery chemistries such as lead-acid or lithium-ion can be used, where the batteries can be readily charged.

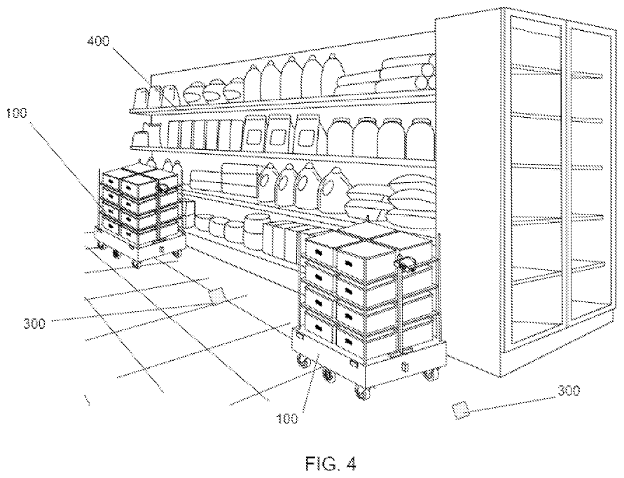

FIG. 4 illustrates the autonomous mobile robot, 100, driving within a warehouse. Markers, 300, are placed on the floor which allows for accurate positioning of the robot. Inventory is stored on shelves 400, within the warehouse.

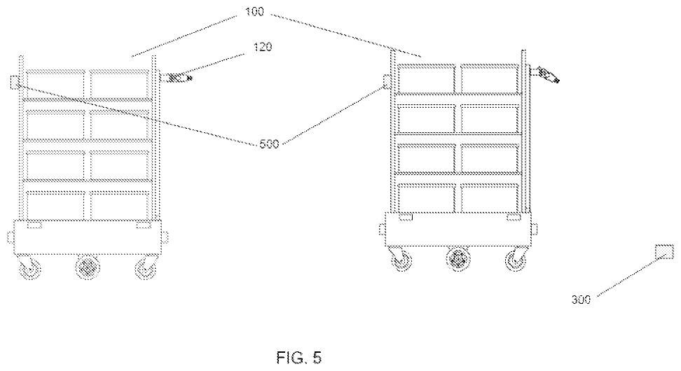

In one embodiment, FIG. 5, markers, 500, are added to the back of the autonomous mobile robot. These markers, 500, are standard fiducial markers such as AprilTags, Aruco markers, and QR codes. The purpose of the markers is that the autonomous mobile robot, 100, can use its rotating camera, 120, to detect the marker on an autonomous robot driving in front of it. This will allow the robot to keep a safe distance when driving behind the robot and position itself within the warehouse when driving behind a lead autonomous mobile robot with known position.

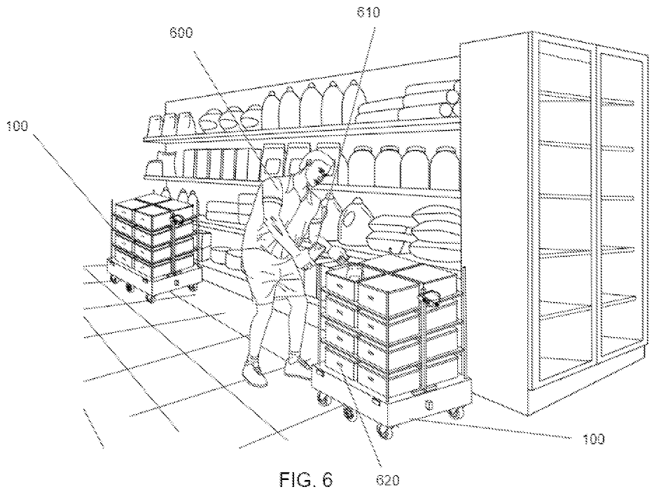

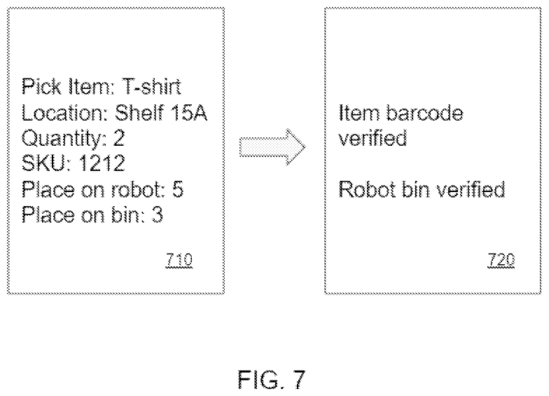

Warehouse personnel can work alongside the autonomous mobile robot, 100. In FIG. 6, a warehouse person 600 is loading items onto an autonomous mobile robot. The warehouse person is instructed to load or unload items using a handheld device, 610. The handheld device is equipped with a barcode scanner that can be used to verify the correct item is being picked. Additionally the totes or bins, 140, on the autonomous mobile robot can be labeled with a number and barcode, 620. This warehouse person can scan this barcode using the handheld device, 610. Typically for e-commerce fulfillment, multiple orders are being picked onto a single robot. Also each order can have multiple items. When picking orders, typically all items associated with a single order should be loaded on the same bin or tote. By scanning the bin and item, the warehouse worker can increase order picking accuracy. In one embodiment, FIG. 7, Illustrates the warehouse personnel interaction with the handheld device 610. In 710, the warehouse person is instructed to pick a specific item along with the location of the item. Details where to place the item onto an autonomous mobile robot is also provided. Finally after the warehouse person using the handheld device, 610, scans the item and bin on the robot, a confirmation screen, 720, is displayed on the handheld device.

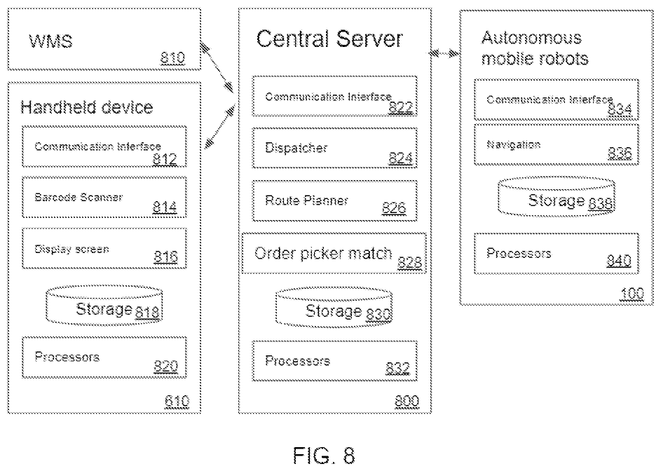

Details of the system are shown in FIG. 8, which comprises autonomous mobile robots 100, central server 800, handheld devices 610, and a warehouse management system (WMS) 810. The central server 800 is virtually placed and has a communication interface 822, with the autonomous mobile robot 834, handheld device 812 and WMS 810. The communication interface uses various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Message Queuing Telemetry Transport (MQTT), File Transfer Protocol (FTP), ZigBee, infrared (IR), IEEE 802.11, 802.16, 2G, 3G, 4G, 5G cellular communication protocols, and/or Bluetooth (BT) communication protocols. The communication interface 822 may include, but is not limited to, the Internet, a cloud network, a Wireless Fidelity (Wi-Fi) network, a Wireless Local Area Network (WLAN) and a Local Area Network (LAN). In an embodiment, the central server 800 is a cloud based system.

In FIG. 8, the central server 800 receives multiple orders from a WMS 810. After receiving orders the central server 800 determines which autonomous mobile robot should be used to collect all items needed for the order. The central server dispatcher 824 determines which autonomous mobile robot 100 should be used. The central server also provides the specific route for each autonomous mobile robot using a route planner 826. The central server has onboard storage 830 and processing 832. The route information is communicated to the autonomous mobile robot using the communication interface 822 and 834. The autonomous mobile robot has onboard processing 840 and storage 838 which can be used for autonomous navigation 836 within a warehouse. The order picker matcher 828, determines which warehouse personnel should load or unload specific items onto an autonomous mobile robot. The warehouse person is instructed using the handheld device the person is carrying 610. In one embodiment a display screen, 816 is used to inform the person and the barcode scanner 814 can be used to verify the item being picked from the warehouse. The handheld device also has onboard processing 820 and storage 818.

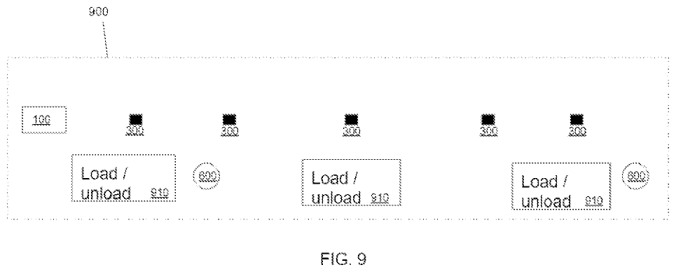

FIG. 9 provides an aerial view embodiment of a section of a warehouse 900 using an autonomous mobile robot 100. In one embodiment, markers are placed on the floor 300 and the robot stops at different locations 910 to load/unload inventory. Warehouse personnel, 600 can load or unload items from the autonomous mobile robot.

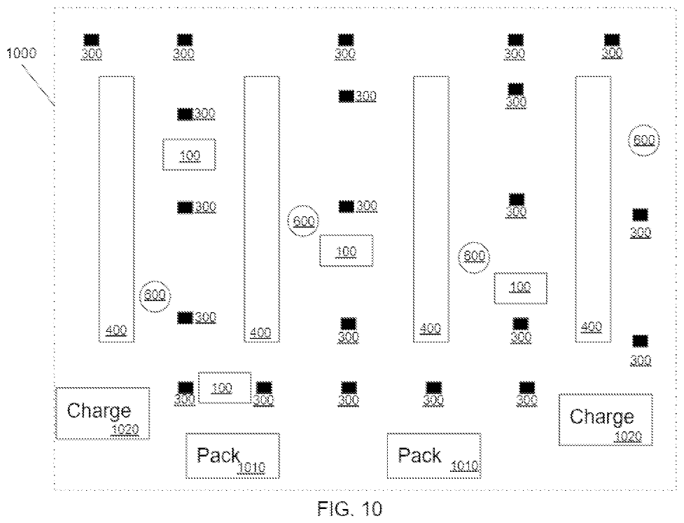

FIG. 10 provides an aerial view embodiment of order picking fulfillment using multiple autonomous mobile robots, 100. In this section, 1000, multiple aisles of inventory are stored, 400. Markers 300 are placed within the warehouse that allows for navigation of the autonomous mobile robots 100. Central server 800, instructs the warehouse personnel 600 to load or unload items on a given robot. Once all items are loaded onto an autonomous mobile robot, 100, the robot navigates to the pack station 1010 where the orders are packed and labeled for shipping. Also charging stations are located within the warehouse, 1020 so that the autonomous mobile robot 100 can autonomously charge itself.

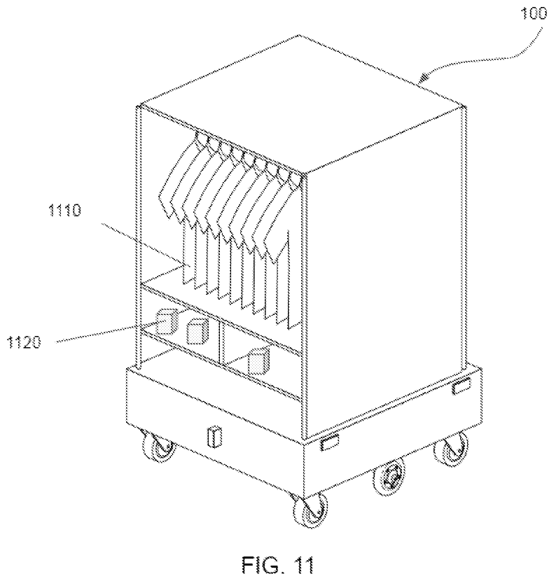

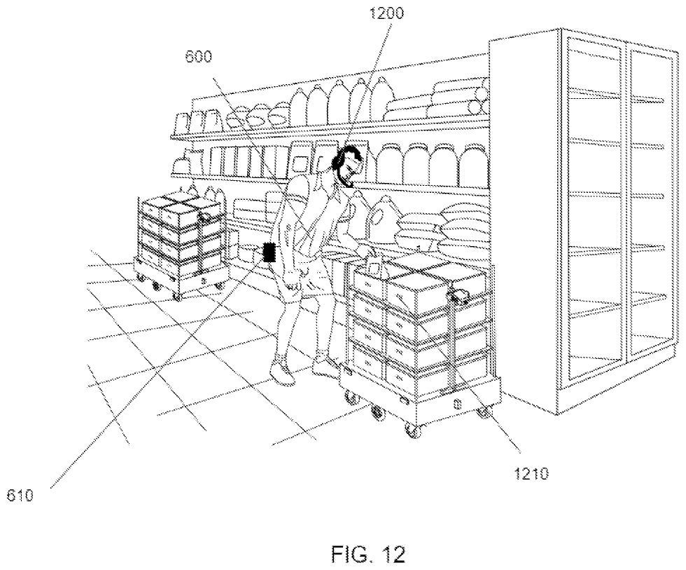

FIG. 11 illustrates an embodiment of the autonomous mobile robot 100 holding objects of different sizes and shapes. The autonomous mobile robot 100, can be configured to hold clothes 1110 and smaller items 1120. FIG. 12. Illustrates an embodiment of the warehouse personnel using a headphone with a mic 1200 for order picking. The handheld device, 610 is mounted on the side of the person and the headphone connects to the handheld device using bluetooth. Instructions on which item to load onto the mobile robot are broadcast to the person using the headphone. The person can verify the item being picked by reading a 2 or 3 digit verification code. An example of a verification code can be the last 2 or 3 digits of the item barcode. The handheld device has speech recognition software to process the verification code. Also each tote on the autonomous mobile robot can have a verification code, 1210.

It will be apparent to those skilled in the art that various modifications and variations can be made to the present invention without departing from the spirit and scope of the invention. The particular embodiments, methods and systems disclosed are meant to be illustrative and not limit the scope of the invention

1. Goods or inventory movement system within a warehouse or indoor facility, comprising of:
a. A plurality of autonomous mobile robots that are equipped with one or more wheels powered using an electric motor, onboard battery, a remote communication interface, memory, one or more processors, a rotating camera, and one or more sensors.
b. ground detection markers or codes placed within the warehouse or indoor facility, that guides the said autonomous mobile robot. The robot utilizes its rotating camera to detect the markers for navigating within the facility.
c. central server comprising of a communication interface, one or more processors, and memory,
d. said central server instructs the said autonomous mobile robots to drive autonomously to a specific spot on the map, whereby specific items can be loaded or picked from the autonomous mobile robot.

2. The system of claim 1, where the autonomous mobile robot can use the rotating camera to detect a detection marker placed on a second robot autonomous mobile robot.

3. The system of claim 1, where the autonomous mobile robot can stop at a ground marker or any point in between for goods to be placed or removed from the robot.

4. The system of claim 1, where the autonomous mobile robot uses the rotating camera and ground markers for accurate control and alignment.

5. The system of claim 1, where the autonomous mobile robot can be configured in various sizes and hold items varying in size and shape.

6. An order picking system within a logistics facility, comprising of:
a. A plurality of autonomous mobile robots that are equipped with one or more wheels powered using an electric motor, onboard battery, a remote communication interface, memory, one or more processors, and one or more sensors.
b. People equipped with a handheld terminal that has a barcode scanner, communication interface, memory, and display screen.
c. central server comprising a communication interface, one or more processors, and memory.
d. said central server instructs the said autonomous mobile robots to drive autonomously to a position within the warehouse.
e. said central server instructs people using the handheld terminal to load or unload items onto an autonomous mobile robot.

7. The system of claim 6, where ground markers are placed within a warehouse.

8. The system of claim 7, where a rotating camera is mounted to an autonomous mobile robot that allows for detection of ground markers for precise control and navigation.

9. The system of claim 8, where markers are placed on the back of an autonomous robot for keeping safe distance between robots.

10. The system of claim 5, where the central server provides a route for the autonomous mobile robot to take within the logistics facility.

11. The system of claim 5, where the autonomous mobile robot can be configured in various sizes and hold items varying in size and shape.

12. The system of claim 5, where a warehouse person is given audio instructions on loading or unloading specific items onto an autonomous mobile robot.

13. The system of claim 5, where a warehouse person uses speech to verify the correct item is being picked and loaded to the correct bin or tote on the autonomous mobile robot.

14. The system of claim 5, where a barcode scanner on the handheld device is used to verify the correct item is being picked and loaded to the correct bin on the autonomous mobile robot.
